(19) United States
(12) Patent Application Publication
(10) Pub. No.: US 2018/0063628 A1
(43) Pub. Date: Mar. 1, 2018

(54) Earphone set

(71) Applicant: Hugo Lin, New Taipei City (TW)

(72) Inventor: Hugo Lin, New Taipei City (TW)

(21) Appl. No.: 15/253,175

(22) Filed: Aug. 31, 2016

(51) Int. Cl. H04R 1/10

(52) U.S. Cl. CPC H04R 1/1091; H04R 2420/09

(57) ABSTRACT

An earphone set contains: a speaker unit, two wires, a casing, a first earphone jack, and a second earphone jack one-piece injection molded with the first earphone jack. The speaker unit is electrically connected with the first earphone jack and the second earphone jack via the two wires, and the first earphone jack and the second earphone jack are moved and are accommodated in the casing. The casing includes an accommodation chamber configured to accommodate the first earphone jack or the second earphone jack, and the first earphone jack and the second earphone jack alternately move to an operative position and an inoperative position. In addition, when the first earphone jack or the second earphone jack moves to the inoperative position, it is accommodated in the accommodation chamber of the casing.

### FIELD OF THE INVENTION

The present invention relates to an earphone set which contains a first earphone jack and a second earphone jack so as to connect with an audio socket or a variety of electronic devices (such as smartphone, multimedia player or tablet computer).

### BACKGROUND OF THE INVENTION

A conventional jack is in a single type so as to be applicable for a specific electronic device. Thus, as electrically connecting with various electronic devices, preparing jacks of different types so as to cooperate with the various electronic devices is required, thus increasing using cost and inconvenience.

The present invention has arisen to mitigate and/or obviate the afore-described disadvantages.

### SUMMARY OF THE INVENTION

The primary objective of the present invention is to provide an earphone set which contains a first earphone jack and a second earphone jack so as to connect with an audio socket or a variety of electronic devices (such as smartphone, multimedia player or tablet computer).

Another objective of the present invention is to provide an earphone set which is simplified and is used easily.

To obtain above-mentioned objectives, an earphone seat provided by the present invention contains: a speaker unit, two wires, a casing, a first earphone jack, and a second earphone jack one-piece injection molded with the first earphone jack.

The speaker unit is electrically connected with the first earphone jack and the second earphone jack via the two wires, and the first earphone jack and the second earphone jack are moved and are accommodated in the casing. The casing includes an accommodation chamber configured to accommodate the first earphone jack or the second earphone jack, and the first earphone jack and the second earphone jack alternately move to an operative position and an inoperative position. In addition, when the first earphone jack or the second earphone jack moves to the inoperative position, it is accommodated in the accommodation chamber of the casing.

Preferably, the speaker unit is any one of an in-ear speaker unit, an on-ear, and over-ear speaker unit.

Preferably, the first earphone jack and the second earphone jack is universal serial bus (USB) jack or Lightning connector. Preferably, one of the first earphone jack and the second earphone jack has a diameter of 3.5 mm, and the other of the first earphone jack and the second earphone jack is universal serial bus (USB) jack.

Preferably, when one of the first earphone jack and the second earphone jack moves the operative position, the other of the first earphone jack and the second earphone jack moves to the inoperative position.

Preferably, the casing is hollow so as to form the accommodation chamber therein, the casing includes an elongated groove, a body is defined by the first earphone jack and the second earphone jack and covers two ends of the two wires, one end of the first earphone jack, and one end of the earphone jack. The body has a forcing portion extending outwardly from an outer wall thereof, and the forcing portion extends out of the casing via the elongated groove so as to urge the first earphone jack and the second earphone jack to move, after user pushes the forcing portion.

Preferably, the first earphone jack and the second earphone jack rotate relative to the casing along two connection shafts, hence the first earphone jack and the second earphone jack alternately rotate to the operative position and the inoperative position along the two connection shafts.

Preferably, the casing includes a base, a first peripheral part and a second peripheral part which extend outwardly from two ends of the base, wherein the first peripheral part and the second peripheral part extend to two opposite sides of the body defined by the first earphone jack and the second earphone jack, each of the first earphone jack and the second earphone jack has each of the two connection shafts, and between the first peripheral part and the second peripheral part is defined the accommodation chamber configured to house the first earphone jack and the second earphone jack. Preferably, said each connection shaft is hollow, and the two wires are electrically connection with the first earphone jack and the second earphone jack via the two connection shafts, respectively.

Preferably, the casing includes two first shoulders, and the first earphone jack and the second earphone jack include two second shoulders individually, such that when the first earphone jack and the second earphone jack alternately rotate to the operative position and the inoperative position, the two first shoulders stop the two second shoulders.

Preferably, each of the two first shoulders is configured on an outer wall of said each connection shaft.

### BRIEF DESCRIPTION OF THE DRAWINGS

FIG. 1 is a side plane view showing the application of an earphone set according to a first embodiment of the present invention.

FIG. 2A is a cross sectional view showing the assembly of a part of the earphone set according to the first embodiment of the present invention.

FIG. 2B is another cross sectional view showing the assembly of a part of the earphone set according to the first embodiment of the present invention.

FIG. 3 is another side plane view showing the application of the earphone set according to the first embodiment of the present invention.

FIG. 4 is a side plane view showing the application of an earphone set according to a second embodiment of the present invention.

FIG. 5A is a cross sectional view taken along the line A-A of FIG. 4.

FIG. 5B is another sectional view taken along the line A-A of FIG. 4.

FIG. 5C is also another sectional view taken along the line A-A of FIG. 4.

FIG. 6 is another side plane view showing the application of the earphone set according to the second embodiment of the present invention.

### DETAILED DESCRIPTION OF THE PREFERRED EMBODIMENTS

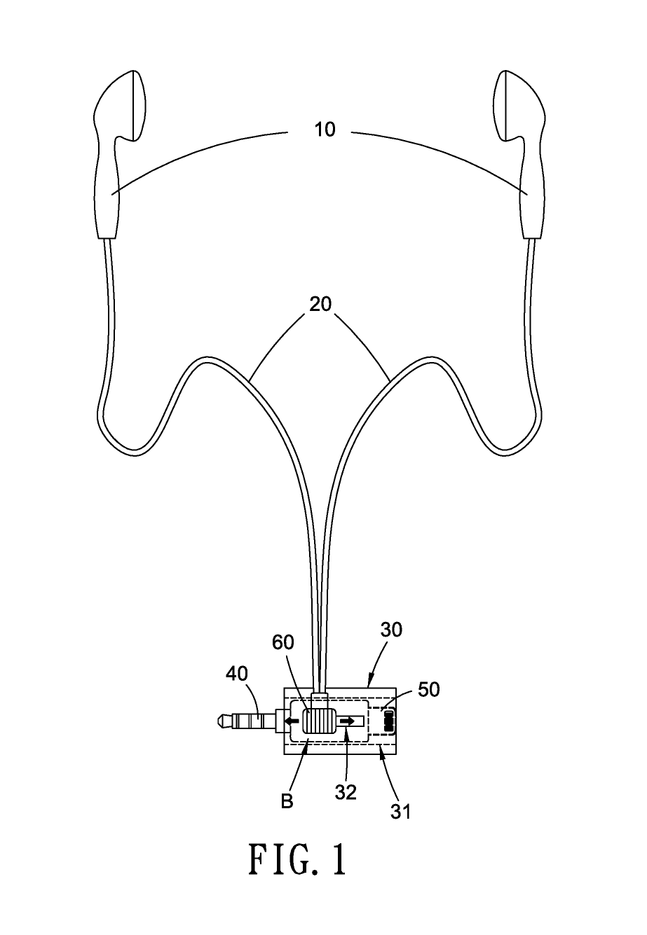

With reference to FIGS. 1 and 3, an earphone set according to a first embodiment of the present invention comprises: a speaker unit 10, two wires 20, a casing 30, a first earphone jack 40, and a second earphone jack 50.

The speaker unit 10 is electrically connected with the first earphone jack 40 and the second earphone jack 50 via the two wires 20, and the first earphone jack 40 and the second earphone jack 50 are moved and are accommodated in the casing 30, wherein the casing 30 includes an accommodation chamber 31 configured to accommodate the first earphone jack 40 or the second earphone jack 50, and the first earphone jack 40 and the second earphone jack 50 alternately move to an operative position and an inoperative position, for example, when the first earphone jack 40 or the second earphone jack 50 moves to the inoperative position, it is accommodated in the accommodation chamber 31 of the casing 30. In other words, when one of the first earphone jack 40 and the second earphone jack 50 moves the operative position, the other of the first earphone jack 40 and the second earphone jack 50 moves to the inoperative position.

The speaker unit 10 is any one of an in-ear speaker unit (as shown in FIG. 1), an on-ear and over-ear speaker unit (as illustrated in FIG. 3). The speaker unit 10 includes two earphones electrically connected with the first earphone jack 40 and the second earphone jack 50 via the two wires 20, respectively.

In assembly, the first earphone jack 40 and the second earphone jack 50 are connected together, wherein the two wires 20 are electrically connected with electrical elements (such as metal pins) of the first earphone jack 40 and the second earphone jack 50 in a parallel connecting manner, respectively. Thereafter, the first earphone jack 40 and the second earphone jack 50 are one-piece injection molded, wherein a body B is defined by the first earphone jack 40 and the second earphone jack 50 and covers two ends of the two wires 20, one end of the first earphone jack 40, and one end of the earphone jack 50, thus manufacturing the earphone set easily and securely.

Preferably, one of the first earphone jack 40 and the second earphone jack 50 has a diameter of 3.5 mm, and the other of the first earphone jack 40 and the second earphone jack 50 has an electrical pin. Furthermore, the first earphone jack 40 and the second earphone jack 50 is universal serial bus (USB) jack or Lightning connector created by Apple Inc.

In one embodiment, the first earphone jack 40 is Lightning connector, and the second earphone jack 50 is universal serial bus (USB) jack. In another embodiment, the first earphone jack 40 has a diameter of 3.5 mm, and the second earphone jack 50 is universal serial bus (USB) jack. Alternatively, the first earphone jack 40 has a diameter of 3.5 mm, and the second earphone jack 50 is Lightning connector. Thereby, the earphone set is electrically connected with an audio socket or a variety of electronic devices (such as smartphone, multimedia player or tablet computer).

In one embodiment, the first earphone jack 40 and the second earphone jack 50 are one-piece injection molded and are moved and accommodated in the casing 30, wherein the casing 30 is hollow so as to form the accommodation chamber 31 therein, and the first earphone jack 40 and the second earphone jack 50 move to the operative position and the inoperative position in the accommodation chamber 31 of the casing 30, wherein when one of the first earphone jack 40 and the second earphone jack 50 is moves to the operative position, said one of the first earphone jack 40 and the second earphone jack 50 extends out of the accommodation chamber 31 of the casing 30, and the other of the first earphone jack 40 and the second earphone jack 50 is partially or is entirely housed in the accommodation chamber 31 of the casing 30.

The casing 30 includes an elongated groove 32, the body B has a forcing portion 60 extending outwardly from an outer wall thereof, and the forcing portion 60 extends out of the casing 30 via the elongated groove 32 so as to urge the first earphone jack 40 and the second earphone jack 50 to move, after user pushes the forcing portion 60. In addition, the forcing portion 60 contacts with the elongated groove 32 so as to fix the first earphone jack 40 and the second earphone jack 50, when the first earphone jack 40 and the second earphone jack 50 move to the operative position or the inoperative position.

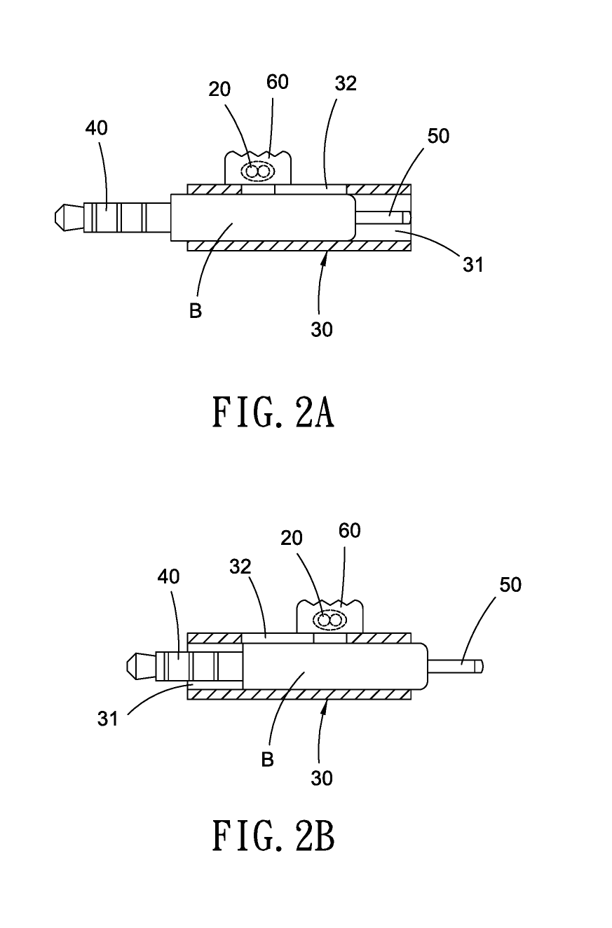

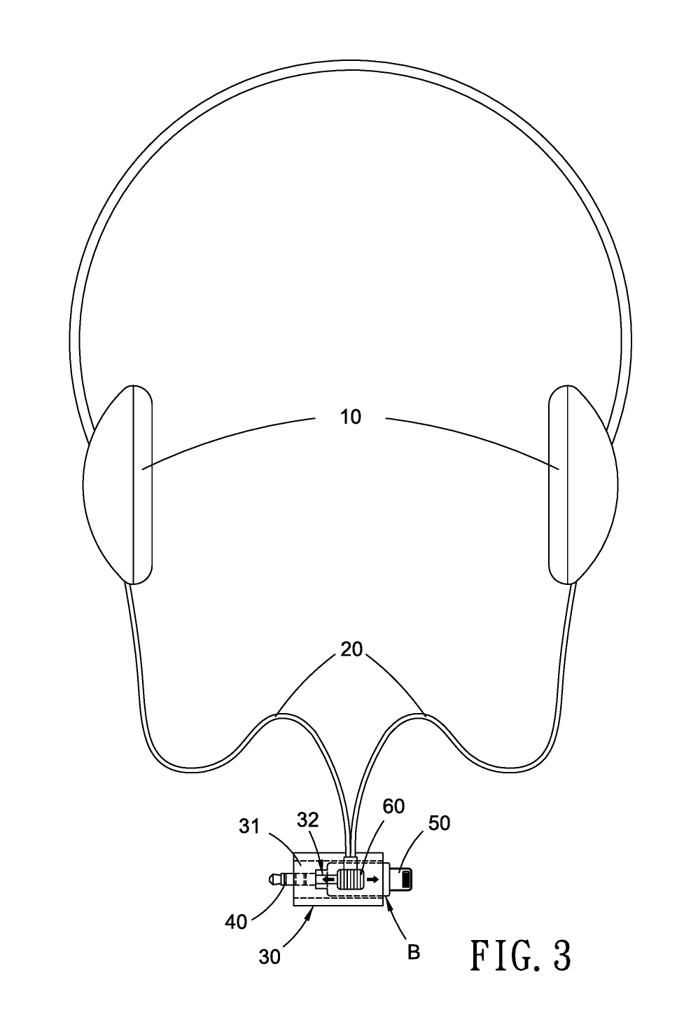

Referring to FIG. 2A, when the first earphone jack 40 moves to the operative position, it extends out of the casing 30, and the second earphone jack 50 is housed in the accommodation chamber 30. As illustrated in FIG. 2B, when the second earphone jack 50 moves to the operative position, it extends out of the casing 30, and the first earphone jack 40 is accommodated in the accommodation chamber 31 of the casing 30.

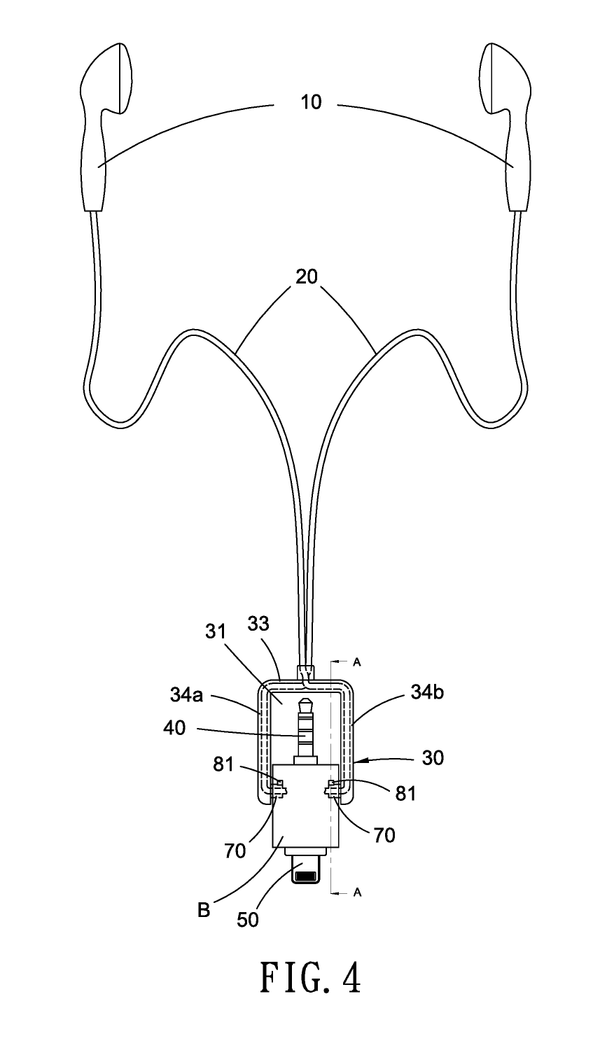

With reference to FIGS. 4 and 6, a difference of an earphone set of a second embodiment from that of the first embodiment comprises: the first earphone jack 40 and the second earphone jack 50 rotating to the operative position and the inoperative position in the accommodation chamber 31 of the casing. Preferably, the speaker unit 10 is any one of an in-ear speaker unit (as shown in FIG. 4), an on-ear and over-ear speaker unit (as illustrated in FIG. 6).

The body B rotates relative to the casing 30 along two connection shafts 70, hence the first earphone jack 40 and the second earphone jack 50 alternately rotate to the operative position and the inoperative position along the two connection shafts 70. Preferably, one of the first earphone jack 40 and the second earphone jack 50, moving to the operative position, extends out of the accommodation chamber 31 of the casing 30, and the other of the first earphone jack 40 and the second earphone jack 50, moving to the inoperative position, is housed in the accommodation chamber 31 of the casing 30. Thereby, the first earphone jack 40 and the second earphone jack 50 do not rotate in the same direction continuously so as to protect the two wires 20.

In addition, the casing 30 includes a base 33, a first peripheral part 34a and a second peripheral part 34b which extend outwardly from two ends of the base 33, wherein the first peripheral part 34a and the second peripheral part 34b extend to two opposite sides of the body B defined by the first earphone jack 40 and the second earphone jack 50, each of the first earphone jack 40 and the second earphone jack 50 has each of the two connection shafts 70, and between the first peripheral part 34a and the second peripheral part 34b is defined an accommodation chamber 31 configured to house the first earphone jack 40 and the second earphone jack 50. Said each connection shaft 70 is hollow, the two wires 20 are electrically connection with the first earphone jack 40 and the second earphone jack 50 via the two connection shafts 70, respectively.

The casing 30 includes two first shoulders 81, and the first earphone jack 40 and the second earphone jack 50 include two second shoulders 82 individually, such that when the first earphone jack 40 and the second earphone jack 50 alternately rotate to the operative position and the inoperative position, the two first shoulders 81 stop the two second shoulders 82 so as to fix the first earphone jack 40 and the second earphone jack 50 at the operative position or the inoperative position. The two connection shafts 70 are fixed in the casing 30, i.e., the first peripheral part 34a and the second peripheral part 34b of the casing 30 has the two connection shafts 70, respectively, and each of the two first shoulders 81 is configured on an outer wall of said each connection shaft 70.

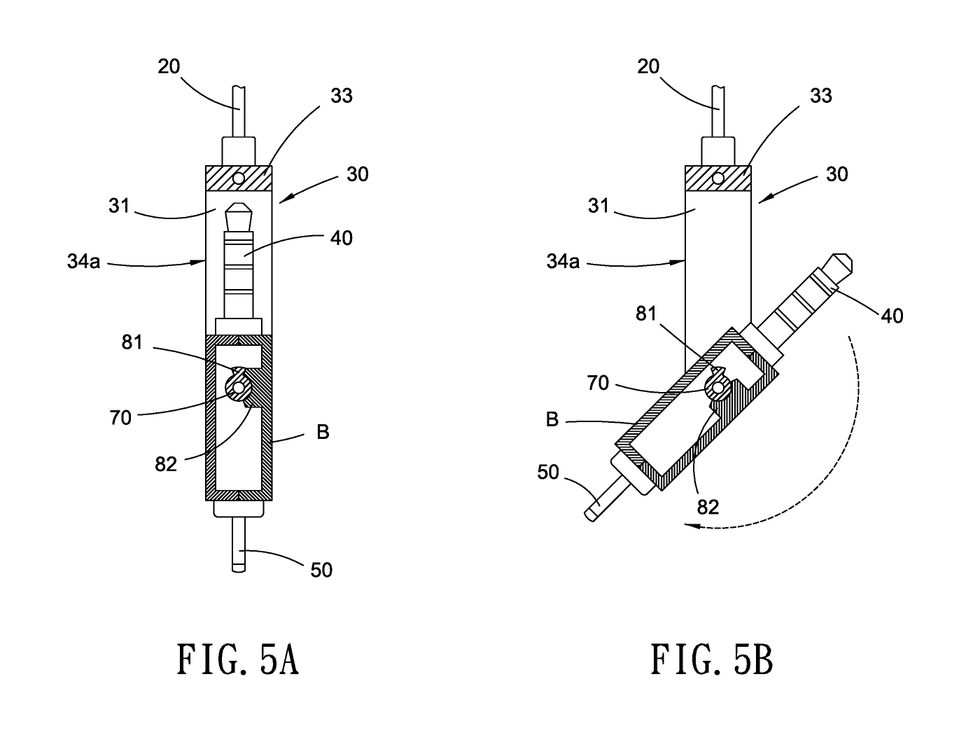

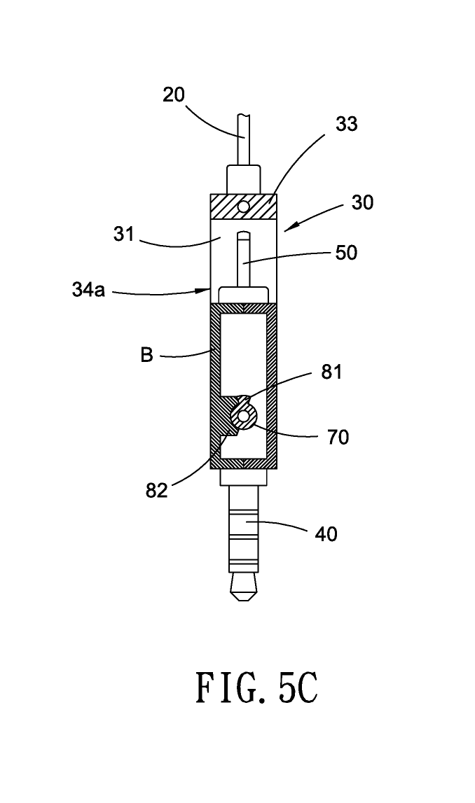

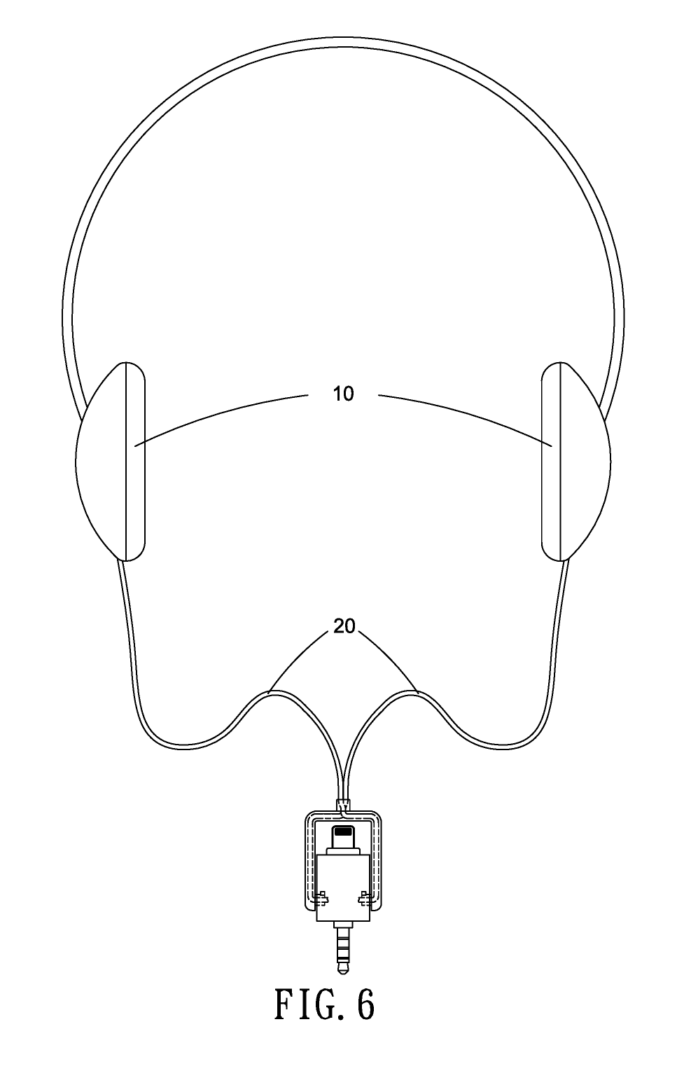

Referring to FIG. 5A, when the second earphone jack 50 rotates to the operative position, the two first shoulders 81 stop the two second shoulders 82, and the first earphone jack 40 is accommodated in the accommodation chamber 31 between the first peripheral part 34a and the second peripheral part 34b. As illustrated in FIG. 5B, when the first earphone jack 40 is rotated to the operative position, the two second shoulders 82 move away from the two first shoulders 81. Referring further to FIG. 5C, when the first earphone jack 42 is rotated to the operative position, the two first shoulders 81 stop the two second shoulders 82 again, and the second earphone jack 50 is housed in the accommodation chamber 31. Thereby, the earphone set is electrically connected with an audio socket or a variety of electronic devices (such as smartphone, multimedia player or tablet computer).

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An earphone set comprising: a speaker unit, two wires, a casing, a first earphone jack, and a second earphone jack one-piece injection molded with the first earphone jack;
wherein the speaker unit is electrically connected with the first earphone jack and the second earphone jack via the two wires, and the first earphone jack and the second earphone jack are moved and are accommodated in the casing, wherein the casing includes an accommodation chamber configured to accommodate the first earphone jack or the second earphone jack, and the first earphone jack and the second earphone jack alternately move to an operative position and an inoperative position, when the first earphone jack or the second earphone jack moves to the inoperative position, it is accommodated in the accommodation chamber of the casing.

2. The earphone set as claimed in claim 1, wherein the speaker unit is any one of an in-ear speaker unit, an on-ear, and over-ear speaker unit.

3. The earphone set as claimed in claim 1, wherein the first earphone jack and the second earphone jack is universal serial bus (USB) jack or Lightning connector.

4. The earphone set as claimed in claim 1, wherein one of the first earphone jack and the second earphone jack has a diameter of 3.5 mm, and the other of the first earphone jack and the second earphone jack is universal serial bus (USB) jack.

5. The earphone set as claimed in claim 1, wherein when one of the first earphone jack and the second earphone jack moves the operative position, the other of the first earphone jack and the second earphone jack moves to the inoperative position.

6. The earphone set as claimed in claim 1, wherein the casing is hollow so as to form the accommodation chamber therein, the casing includes an elongated groove, a body is defined by the first earphone jack and the second earphone jack and covers two ends of the two wires, one end of the first earphone jack, and one end of the earphone jack, and the body has a forcing portion extending outwardly from an outer wall thereof, and the forcing portion extends out of the casing via the elongated groove so as to urge the first earphone jack and the second earphone jack to move, after user pushes the forcing portion.

7. The earphone set as claimed in claim 1, wherein the first earphone jack and the second earphone jack rotate relative to the casing along two connection shafts, hence the first earphone jack and the second earphone jack alternately rotate to the operative position and the inoperative position along the two connection shafts.

8. The earphone set as claimed in claim 7, wherein the casing includes a base, a first peripheral part and a second peripheral part which extend outwardly from two ends of the base, wherein the first peripheral part and the second peripheral part extend to two opposite sides of the body defined by the first earphone jack and the second earphone jack, each of the first earphone jack and the second earphone jack has each of the two connection shafts, and between the first peripheral part and the second peripheral part is defined the accommodation chamber configured to house the first earphone jack and the second earphone jack, wherein said each connection shaft is hollow, and the two wires are electrically connection with the first earphone jack and the second earphone jack via the two connection shafts, respectively.

9. The earphone set as claimed in claim 8, wherein the casing includes two first shoulders, and the first earphone jack and the second earphone jack include two second shoulders individually, such that when the first earphone jack and the second earphone jack alternately rotate to the operative position and the inoperative position, the two first shoulders stop the two second shoulders.

10. The earphone set as claimed in claim 9, wherein each of the two first shoulders is configured on an outer wall of said each connection shaft.
